(19) United States
(12) Patent Application Publication
(10) Pub. No.: US 2006/0133083 A1
(43) Pub. Date: Jun. 22, 2006

(54) Lighting canopy for advertising sign post

(76) Inventor: Michael S. Gelbert, Phoenix, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/016,670

(22) Filed: Dec. 17, 2004

(51) Int. Cl. G09F 13/20; F21V 21/30; F21V 23/04

(52) U.S. Cl. 362/250; 362/248; 362/276; 40/542

(57) ABSTRACT

A sign assembly includes a fixture capable of being attached to a sign support structure. The sign assembly also includes a canopy which can slideably engage the fixture to provide cover for the sign support structure. The canopy can be foldable and can include lights to illuminate a sign held by the sign support structure. The lights can be provided power through contacts which are engaged when the canopy is attached to the fixture.

### BACKGROUND OF THE INVENTION

1. Field of the Invention

The present invention generally relates to signage, and, more particularly, lighting and canopy structures for use with signposts.

2. Related Art and Prior Art Statement

Real estate signs are often used to advertise the sale or lease of a particular piece of property. Typical real estate signs include a vertical post with a horizontal cross-arm which holds an advertising panel displaying information about the sale or lease. This information can include contact information such as the name of the person handling the lease or sale of the property. For effective advertising, the sign should be readable from a distance under different lighting conditions and should catch the prospective buyer or leaser's attention.

Some real estate signs include lighting fixtures positioned over the cross-arm to illuminate the sign. However, these lighting fixtures typically include high power lighting systems which can quickly use up the power from a battery. If they are powered by solar cells, then more are needed to provide more power, which increases costs.

These lighting fixtures also tend to be bulky and difficult to attach and remove from the cross-arm. The bulkiness is a problem because real estate signs are often stored and transported from one location to another. The difficulty in attaching and removing the lighting fixture is a problem because this procedure is often performed by one person. Hence, a bulkier lighting fixture requires more storage space to transport and store it and is also more difficult to assemble and disassemble.

### BRIEF SUMMARY OF THE INVENTION

The present invention provides a sign assembly with a fixture capable of being attached to a sign support structure and a canopy which engages the fixture to provide cover for the sign support structure. In one embodiment, the canopy can be foldable and can include light source(s) positioned to illuminate a first sign held by the sign support structure. The sign assembly can include a power supply which provides power to the light source(s) through electrical contacts. The electrical contacts can be frictionally engaged when the canopy engages the fixture. In some embodiments, the sign assembly can include a sign holding fixture coupled to the canopy. The sign holding fixture can include a slot for receiving a second sign and light source(s) positioned to illuminate the second sign.

The present invention also provides a sign assembly which includes a fixture capable of being attached to the sign support structure and a foldable canopy capable of being attached to the fixture. The fixture and foldable canopy can be slideably engaged with tongue and groove structure(s). The canopy can include first and second panels hinged together so that the angle between them can be adjusted.

In this embodiment, the foldable canopy can include light source(s) to illuminate a sign held by the sign support structure. One or more light sensors can be coupled to the light source(s) to operate them in response to the amount of light receive by the sensor(s). Electrical contacts can be positioned on the fixture and canopy so that they are electrically engaged when the canopy is attached to the fixture.

The sign assembly can include a power supply which provides a power signal to the electrical contacts. The electrical contacts can include first and second electrical contacts positioned on the fixture and foldable canopy, respectively, so that the first and second electrical contacts are frictionally engaged when the fixture is attached to the foldable canopy.

The present invention further provides a sign assembly with a fixture configured to be coupled to a sign support structure and a canopy coupled to the fixture. The fixture includes a first electrical contact and the canopy includes a second electrical contact. The first and second electrical contacts are engaged when the canopy is coupled to the fixture. The canopy can include first and second panels coupled together with a living hinge. In some embodiments, the canopy is frictionally engaged to the fixture. The canopy can include a first lighting system electrically coupled to the power source for providing light to a first sign included in the sign support structure.

In one embodiment, the sign assembly can include first and second electrical contacts which electrically couple the first power supply and lighting system. The first and second electrical contacts can be coupled together by the frictional engagement between the fixture and canopy. In some embodiments, a sign holding fixture can be coupled to the canopy. The sign holding fixture can include a slot for receiving a second sign and a second lighting system for providing light to the second sign. A second power supply can provide power to the second lighting system or the power can be provided by the first power supply.

The present invention also provides a sign assembly which includes a fixture that can be removably attached to a post. The sign assembly also includes a foldable canopy which slideably engages the fixture and a sign holding fixture coupled to the foldable canopy. The sign holding fixture includes a slot for holding a first sign. In one embodiment, the fixture and canopy are frictionally coupled together with tongue and groove structure(s). The foldable canopy can include first and second panels hinged together.

In some embodiments, first and second lighting systems are positioned on the foldable canopy and sign holding fixture, respectively, to provide light in desired directions. The first and second lighting systems are provided power by separate power supplies. A light sensor is included to turn on or off at least one of the first and second lighting systems in response to the amount of light received by the light sensor.

Additionally, the present invention provides a display apparatus which includes a foldable canopy coupled to a sign support structure. A fixture can be positioned to attach the foldable canopy to the sign support structure. The fixture and the foldable canopy can be slideably engaged together. The foldable canopy can include first light source(s) positioned to illuminate a first sign held by the sign support structure. In some embodiments, the display apparatus can include a sign holding fixture coupled to the foldable canopy. The sign holding fixture can include a slot for receiving a second sign and second light source(s) positioned to illuminate the second sign.

These and other features, aspects, and advantages of the present invention will become better understood with reference to the following drawings, description, and claims.

### BRIEF DESCRIPTION OF THE DRAWINGS

Referring to the drawings:

FIG. 1 is a simplified exploded perspective view of a display apparatus in accordance with the present invention;

FIG. 2 is a simplified unexploded perspective view of the display apparatus of FIG. 1;

FIG. 3 is a simplified perspective view of one embodiment of a fixture, in accordance with the present invention, which includes a storage housing;

FIG. 4 is a simplified front view of the display apparatus of FIG. 1;

FIG. 5 is a more detailed perspective view of a sign holding fixture included in the display apparatus of FIG. 1;

FIG. 6 is a more detailed perspective view of a fixture included in the display apparatus of FIG. 1;

FIG. 7 is a bottom view of a canopy included in the display apparatus of FIG. 1;

FIG. 8 is a more detailed perspective view of a groove included in the display apparatus of FIG. 1; and

FIGS. 9a and 9b are simplified circuit schematics of the electrical lighting systems included in the canopy and sign holding fixture, respectively, of FIG. 1.

### DETAILED DESCRIPTION OF THE INVENTION

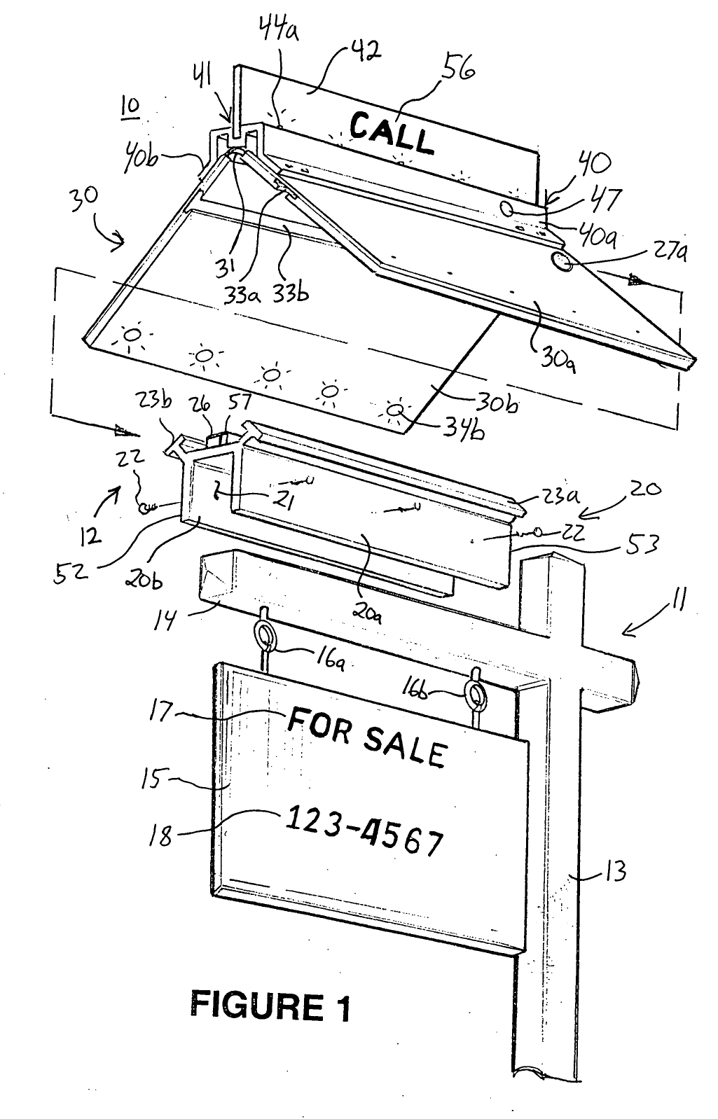

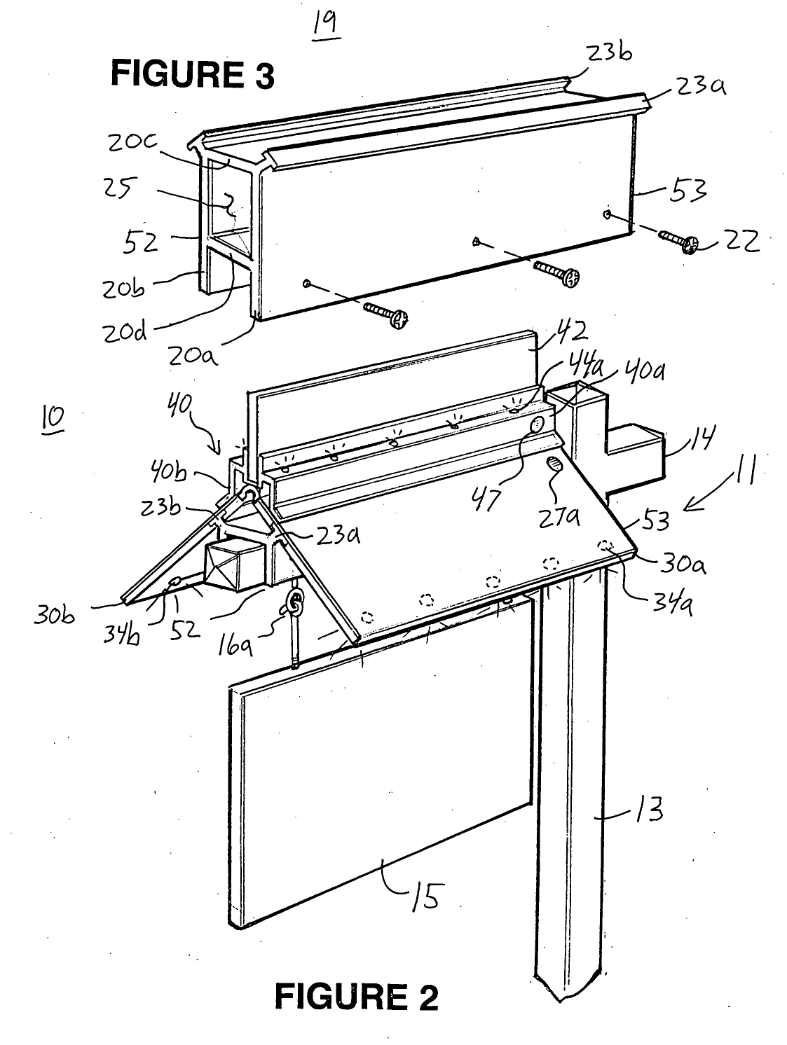

FIGS. 1 and 2 are simplified perspective views of a display apparatus 10 in accordance with the present invention. FIG. 1 is an exploded perspective view and FIG. 2 is an unexploded perspective view. It should be noted that like reference characters indicate corresponding elements throughout the several views. Apparatus 10 can be used as a sign to convey information to a viewer. For example, it can be used as a real estate sign where it is desired to provide information about the sale or lease of real estate, although other information can be provided. It is typically desired to provide this information so it is viewable day and night and under different lighting conditions.

Display apparatus 10 includes a sign support structure 11 and a sign assembly 12. Sign support structure 11 includes an upstanding post 13 which supports a cross-arm post 14. A lower end (not shown) of post 13 is typically embedded into the ground so that it stands upright. Support structure 11 shown in FIG. 1 is the configuration typically used for real estate displays and is shown for simplicity and ease of discussion. It should be noted, however, that sign support structure 11 can be configured in many different ways.

Cross-arm post 14 supports a sign 15 which depends downwardly therefrom and displays information which is desired to convey to a viewer. The information includes lettering 17 and numbering 18, but it could include other indicia or images such as a picture. Sign 15 is typically held in a position above the ground and at a level where it is easy to view. In this example, sign 15 is coupled to post 14 with hook and loop structures 16a and 16b, although sign 15 can be coupled to post 14 with other fasteners.

In accordance with one embodiment of the invention, sign assembly 12 includes a fixture 20 which is engageable to a post 14 and a canopy 30 which is engageable to fixture 20. Fixture 20 is attached to cross-arm post 14 with screws 22 although other fasteners could be used. In some embodiments, it is generally desired to attach fixture 20 to post 14 temporarily, so the type of fastener can be chosen to make it easy to separate them. In other embodiments, where it may not be desired to easily detach fixture 20 from post 14, an adhesive or another more permanent fastening method can be used.

In this embodiment, fixture 20 is shaped like an inverted U with opposed walls 20a and 20b coupled together with a wall 20c. Walls 20a and 20b are spaced apart to form a slot 21 which receives cross-arm post 14. Walls 20a and 20b are parallel to each other and perpendicular to wall 20c. Slot 21 and walls 20a, 20b, and 20c extend between ends 52 and 53 of sign assembly 12 so that slot 21 is shaped to receive post 14. It should be noted, however, that fixture 20 can have other features and/or shapes so that it can be mounted to structure 11 in substantially the same manner as that shown in FIGS. 1 and 2. For example, other shapes for fixture 20 can be provided by curving sides 20a, 20b, and/or 20c if cross-arm 14 has a curved cross-sectional shape instead of square as shown.

In accordance with the invention, canopy 30 is foldable so that it is easily transported to and from various locations in a compact manner. This also makes it easier to store assembly 12 because less storage space is required if canopy 12 is foldable. Here, canopy 30 includes panels 30a and 30b coupled together with a living hinge 31. Panels 30a and 30b each have inner edges coupled together by hinge 31 and outer edges which extend away and downward from hinge 31. Panels 30a and 30b also have inner surfaces 37a and 37b, respectively, and outer surfaces 38a and 38b, respectively.

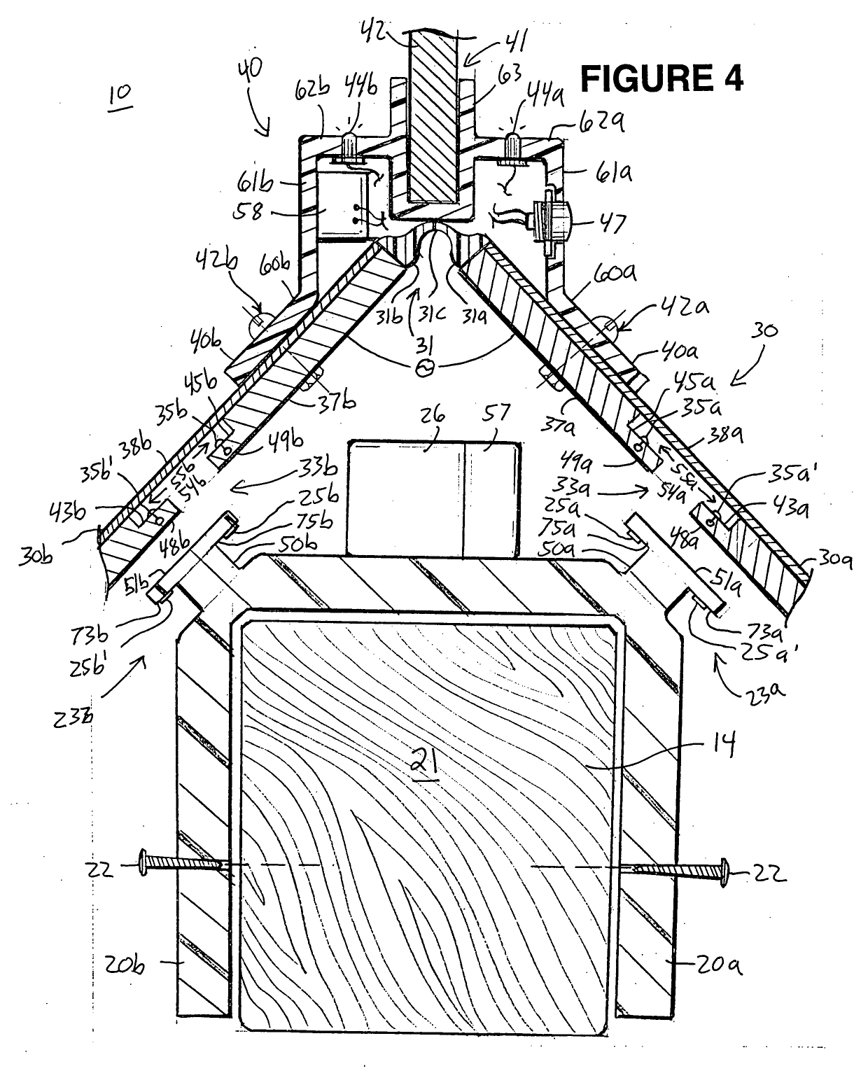

The use of a living hinge here is for illustrative purposes. Accordingly, panels 30a and 30b can be hinged together with other types of structures so that angle θ between panels 30a and 30b can be adjusted. Angle θ can be seen better in FIG. 4 which is a simplified front view of display apparatus 10 looking in a direction along cross-arm 14 towards post 13 from end 52 to end 53.

Hinge 31 includes a central flexible portion 31c with coupling portions 31a and 31b attached to respective inner edges of panels 30a and 30b. Hinge 31 is continuous between ends 52 and 53, although it could be segmented so that the segments cooperate as a single continuous hinge structure. Hinge 31 is flexible so that angle θ between panels 30a and 30b is adjustable. For example, when it is desired to store and/or transport canopy 30, θ can be made zero so that inner surfaces 37a and 37b are adjacent to one another. In this way, panels 30a and 30b can be superimposed when canopy 30 is folded. In another example, the hinge can allow θ to be adjusted to 180° so that panels 30a and 30b can be made to lie flat. It should be noted, however, that in some embodiments, canopy 30 does not have to be foldable.

Fixture 20 and canopy 30 are formed to be light weight so they can be easily mounted and dismounted from sign support structure 11 and from each other. To make fixture 20 and canopy 30 lightweight, they are formed out of materials which are also light weight so that these components are more easily moved and assembled and disassembled. Suitable materials can include plastic, wood, and ceramics among others. The material should also be able to withstand weathering so that these components are durable and have a long lifetime when positioned outdoors.

To make it easy to engage fixture 20 and canopy 30, they are slideably coupled together with tongue and groove structures or other male and female coupling components. In this way, they are also removably coupled together. Here, fixture 20 includes tongue structures 23a and 23b which are fixedly attached to it and canopy 30 includes grooves 33a and 33b which are adapted to receive tongues 23a and 23b. Tongue 23a is positioned along the intersection of walls 20a and 20c of fixture 20 and tongue 23b is positioned along the intersection of walls 20b and 20c. Tongue 23a includes a base portion 50a which extends outward and at an angle from the intersection region of walls 20a and 20c. Tongue 23a has a rail portion 51a which extends outwardly from and perpendicular to the outermost surface of base portion 50a so that tongue 23a is T shaped. Rail portion 51a has surfaces 73a and 75a which are positioned on opposite sides of base portion 50a and face inwardly towards walls 20a and 20c, respectively.

Likewise, tongue 23b includes a base portion 50b which extends outward and at an angle from the intersection region of walls 20b and 20c. Tongue 23b has a rail portion 51b which extends outwardly from and perpendicular to the outermost surface of base portion 50b so that tongue 23b is T shaped. Rail portion 51b has surfaces 73b and 75b which are positioned on opposite sides of base portion 50b and face inwardly towards walls 20b and 20c, respectively. In this embodiment, tongues 23a and 23b are continuous between ends 52 and 53, although they could be segmented so that the segments cooperate as a single continuous tongue structure.

It should be noted that fixture 20 is formed as a single piece which can be a moldable plastic, for example. However, it can be formed in separate pieces which are then coupled together. For example, walls 20a, 20b, and 20c can be separate plastic pieces which are then attached together using an adhesive to form the U-shaped structure. Also, tongues 23a and 23b are integrated with respective walls 20a, 20b, and 20c so that they form a single unit. Although, tongues 23a and 23b can be formed separately then attached to respective walls 20a, 20b, and 20c using an adhesive or other fastening devices.

The groove structures of canopy 30 include grooves 33a and 33b formed within panels 30a and 30b, respectively. Groove 33a is positioned along inner surface 37a of panel 30a and groove 33b is positioned along inner surface 37b of panel 30b. Grooves 33a and 33b are spaced a distance from the inner edge of respective panels 30a and 30b so that they can be mated with tongues 23a and 23b, respectively, when canopy 30 is unfolded. Grooves 33a and 33b extend between ends 52 and 53 of sign assembly 12, although they can be segmented so the segments operate as a continuous groove structure.

Groove 33a includes a central opening 54a which extends from inner surface 37a towards outer surface 38a. Groove 33a has a slot 55a which extends outward from opening 54a in opposite directions towards the inner and outer edges of panel 30a. Accordingly, slot 55a forms fingers 48a and 49a which both extend inward towards central opening 55a. Fingers 48a and 49a have surfaces 43a and 45a, respectively, which face slot 55a so that surfaces 43a and 45a are opposed to surface 37a.

Similarly, groove 33b includes a central opening 54b which extends from inner surface 37b towards outer surface 38b. Groove 33b has a slot 55b which extends outward from opening 54b in opposite directions towards the inner and outer edges of panel 30b. Slot 55b forms fingers 48b and 49b which both extend inward towards central opening 55b. Fingers 48b and 49b have surfaces 43b and 45b, respectively, which face slot 55b so that surfaces 43b and 45b are opposed to surface 37b.

In accordance with the invention, tongues 23a and 23b are shaped to engage corresponding grooves 33a and 33b of canopy 30. This can be seen in more detail in FIG. 4. When fixture 20 is engaged to canopy 30, surfaces 73a and 75a of rail 51a are adjacent to surfaces 43a and 45a, respectively, of corresponding fingers 48a and 49a. Similarly, surfaces 73b and 75b of rail 51b are adjacent to surfaces 43b and 45b, respectively, of corresponding fingers 48b and 49b. Hence, grooves 33a and 33b are adapted to receive corresponding tongues 23a and 23b so that fixture 20 and canopy 30 can be slideably engaged. In this way, they can be frictionally coupled together and so they can be easily engaged and disengaged.

It should be noted that tongues 23a,23b and grooves 33a,33b are positioned on fixture 20 and canopy 30, respectively, for illustrative purposes only and that other configurations are possible. For example, tongues 23a,23b and grooves 33a,33b can be positioned on canopy 30 and fixture 20, respectively, in some embodiments. Further, fixture 20 and canopy 30 can also be engaged with fasteners or an adhesive.

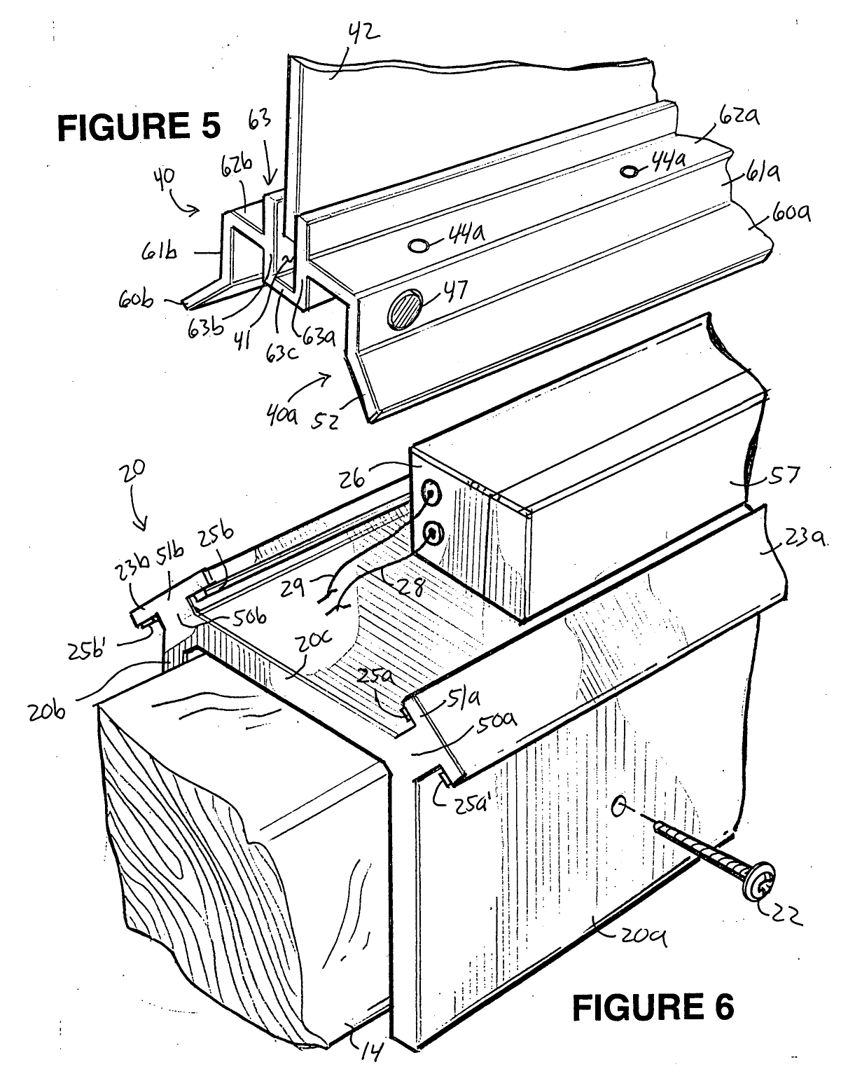

In one embodiment, sign assembly 12 includes a sign holding fixture 40 coupled to canopy 30. This can be seen in FIGS. 4 and 5, in which FIG. 5 is a perspective view of sign holding fixture 40. In this example, sign holding fixture 40 includes flanges 40a and 40b coupled together with a sign holding member 63. Sign holding member 63 is U shaped with opposed walls 63a and 63b coupled together with a wall 63c so that they are parallel to each other and perpendicular to wall 63c. Walls 63a and 63b are spaced apart to form a slot 41 which receives a sign 42. Sign 42 displays lettering 56, but it could also show numbering or other images, such as a picture. It should be noted that in some embodiments, sign holding fixture 40 can be replaced with a mechanical assembly which provides structural strength to sign assembly 12. In these embodiments, the mechanical assembly does not have to include a slot for receiving a sign.

Slot 41 and walls 63a, 63b, and 63c extend between ends 52 and 53 of sign assembly 12 so that slot 41 is shaped to receive sign 42. Slot 41 is oriented so that sign 42 is held in an upright position and the information displayed by sign 42 is conveyed to a viewer. It should be noted, however, that sign holding portion 63 can have other features and/or shapes so that it can hold sign 42 in substantially the same manner as that shown in FIGS. 4 and 5.

Flange 40a includes an outwardly extending member 62a with one edge coupled with and perpendicular to wall 63a. The opposed edge of member 62a is coupled to one edge of a downwardly extending member 61a, which extends perpendicular to member 62a. A flared member 60a is coupled to the opposed edge of member 61a and angled in a downward direction so that it can be coupled to panel 30a of canopy 30 when canopy 30 is unfolded. Flared member 60a is coupled to panel 30a with nut and bolt assembly 42a, as shown in FIG. 4. However, member 60a can be coupled to panel 30a with other fastening devices or an adhesive.

Similarly, flange 40b includes an outwardly extending member 62b with one edge coupled to and perpendicular to wall 63b. The opposed edge of member 62b is coupled to one edge of a downwardly extending member 61b, which extends perpendicular to member 62b. A flared member 60b is coupled to the opposed edge of member 61b and angled in a downward direction so that it can be coupled to panel 30b of canopy 30 when canopy 30 is unfolded. Flared member 60b is coupled to panel 30b with nut and bolt assembly 42b, as shown in FIG. 4. However, member 60b can be coupled to panel 30b with other fastening devices or an adhesive. It should be noted that flanges 40a and 40b can have other shapes or structural features so they can couple sign holding member 63 and/or provide mechanical strength to canopy 30.

In some embodiments of sign assembly 12, lighting systems are included to illuminate signs 15 and/or 42. The lighting systems for signs 15 and 42 can be separate or they can be electrically coupled together. For example, the lighting systems can have separate power sources and they can also have separate light sensors and/or control circuitry to turn them on and off in response to the ambient light. In other examples, the lighting systems can be electrically coupled to the same power source and they can be turned on and off by the same light sensor and/or control circuitry.

The lighting systems included in sign assembly 12 can be seen in FIG. 4. In this particular embodiment, the lighting systems are separate, as discussed in more detail below. Accordingly, fixture 20 includes a lighting system for providing light in a desired direction and sign holding fixture 40 includes another lighting system for providing light in another desired direction. For the lighting systems included in fixture 20 and fixture 40, the desired directions are towards signs 15 and 42, respectively, so that the corresponding signs are illuminated.

The lighting system for sign 15 includes lights 34a and 34b coupled to corresponding light sensors 27a and 27b and supported by panels 30a and 30b, respectively, as shown in FIGS. 1 and 2. Lights 34a and 34b are on opposing sides of sign 15 to that they can provide illumination to both sides. They are positioned towards the outer edge of respective panels 30a and 30b and directed towards corresponding sides of sign 15 to provide sufficient illumination to a desired area of it. The lighting system for sign 42 includes lights 44a and 44b coupled to light sensor 47 and supported by sign holding fixture 40, as shown in FIGS. 1, 2, and 4. Lights 44a and 44b are on opposing sides of sign 42 to provide illumination to both sides of it and over a desired area. It should be noted that only one side of signs 15 and/or 42 could be illuminated by their respective lights, but both sides are illuminated in this example for illustrative purposes.

In accordance with the invention, lights 34a,34b and 44a,44b include low power light sources, such as light emitting diodes. Light emitting diodes use less power, provide higher light intensities, and have longer lifetimes than incandescent lights. It should be noted, however, that other light sources, such as incandescent or fluorescent lights, can be used in some embodiments. If a light emitting diode is used, it may be desirable to have it emit white light to provide the best illumination of signs 15 and 42, although other colors can be used.

For example, signs 15 and 42 can include phosphorescent or afterglow materials in lettering 17, 56, and/or numbering 18. These materials provide visible light in response to receiving incident light of a shorter wavelength than the visible light. Accordingly, lights 34a,34b and 44a,44b can include ultraviolet light emitting diodes or other light sources which emit light at shorter wavelengths then the light provided by the phosphorescent material. Some afterglow effect materials include polycrystalline inorganic zinc sulphide (green afterglow) or alkaline earth sulphides (red or blue afterglow), and can be used in paints or inks and applied to signs 15 and/or 42.

An advantage in this embodiment is that light sources 34a,34b and 44a,44b do not need to be operated continuously which decreases the amount of power used. Lights 34a,34b and 44a,44b can be operated long enough to cause the afterglow material included in signs 15 and 42 to phosphoresce and then turned off. Lights 34a,34b and 44a,44b can then be turned back on when the phosphoresce decreases below a predetermined intensity. These steps can be repeated as much as desired.

A power supply 26 provides power to light sources 34a and 34b and a power supply 46 provides power to light sources 44a and 44b. Light sources 34a and 34b are operated by control circuitry 57 and light sources 44a and 44b are operated by control circuitry 58. Power supply 26 and circuitry 57 are carried by fixture 20 and power supply 46 and circuitry 58 are carried by sign support fixture 40. In this particular example, power supply 26 and circuitry 57 are positioned on wall 20c of fixture 20 and power supply 46 and circuitry 58 are attached to an inside surface of member 61b. However, it should be noted that these elements can be positioned at other locations throughout sign assembly 12.

Power supplies 26 and 46 can include fuel cells and/or batteries, which can be rechargeable. The batteries can be recharged in many different ways, including solar energy or energy provided by an AC adapter. Control circuitry 57 and 58 can include analog and/or digital logic circuitry known in the art to provide signals to control the operation of light sources 34a,34b and 44a,44b, respectively. Control circuitry 57 and 58 can be formed as separate modules or they can be integrated with respective power sources 26 and 46.

Power from supplies 26 and 46 can be provided to corresponding lights 24a,24b and 44a,44b through wires, conductive interconnects, or other conductors. In this particular example, power source 46 is coupled to light sources 44a and 44b with wires which are housed within sign holding fixture 40 in a conventional manner. Similarly, power source 26 is coupled to light sources 34a and 34b with a combination of wires and interconnects. In particular, opposite polarity terminals of power supply 26 are coupled to wires 28 and 29. Here, wire 28 is coupled to a positive terminal of power source 26 and wire 29 is coupled to a negative terminal. This can be seen in FIG. 6 which is a more detailed perspective view of end 52 showing fixture 20.

Wire 28 is coupled to interconnects 25a and 25b and wire 29 is coupled to interconnects 25a′ and 25b′. In accordance with the invention, interconnects 25a and 25a′ are integrated with tongue 23a and interconnects 25b and 25b′ are integrated with tongue 23b. In this particular embodiment, interconnects 25a and 25a′ are positioned on opposite sides of tongue 23a on surfaces 75a and 73a, respectively. Similarly, interconnects 25b and 25b′ are positioned on opposite sides of tongue 23b on surfaces 75b and 73b, respectively. Accordingly, wires 28 and 29 provide respective interconnects 25a,25b and 25a′,25b′ with opposite polarity signals from power source 26.

In accordance with the invention, interconnects 35a and 35a′ are integrated with groove 33a. Interconnects 35a and 35a′ are positioned on opposite sides of groove 33a on surfaces 45a and 43a, respectively. Similarly, interconnects 35b and 35b′ are integrated with groove 33b. Interconnects 35b and 35b′ are positioned on opposite sides of groove 33b and on surfaces 45b and 43b, respectively. The positioning of interconnects 35a,35a′ and 35b,35b′ can be seen in FIG. 8 which is a more detailed perspective view of groove 33a.

It should be noted that the interconnects can be positioned differently than shown in FIG. 8. However, in accordance with the invention, the positioning of interconnects 25a, 25a′, 25b, and 25b′ is chosen so that they are coupled to corresponding interconnects 35a, 35a′, 35b, and 35b′ when fixture 20 and canopy 30 are engaged. In this way, power supply 26 provides respective interconnects 35a,35b and 35a′,35b′ with opposite polarity signals.

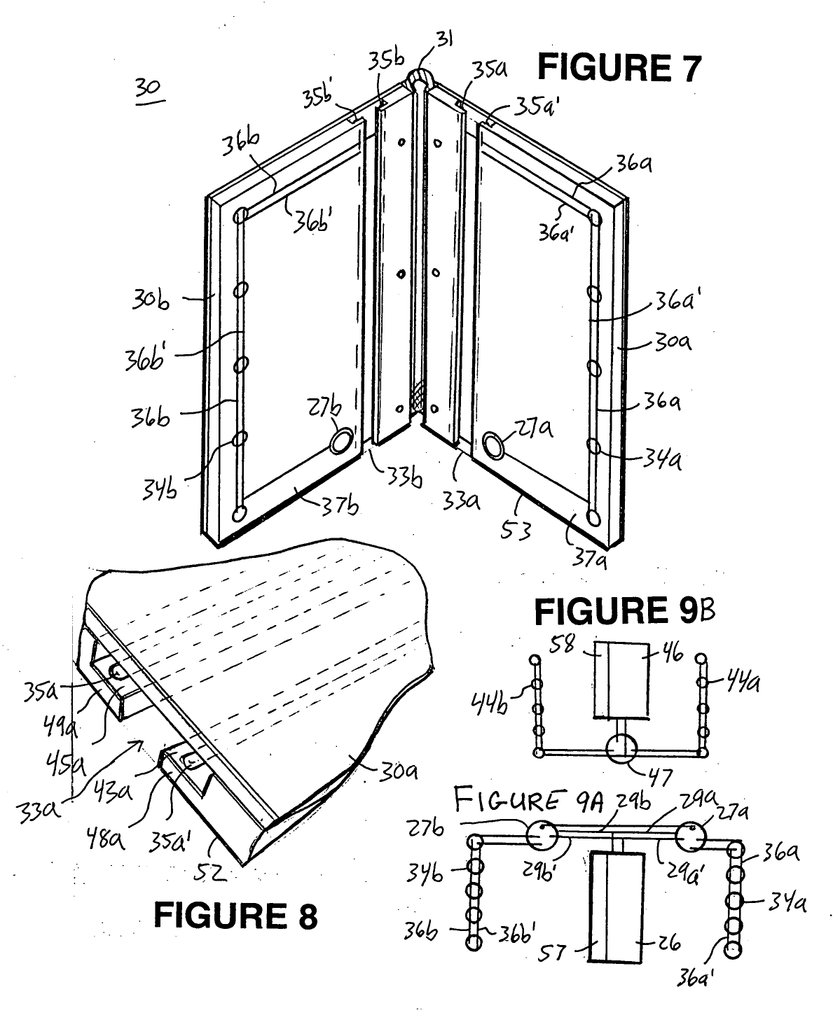

Interconnects 35a and 35a′ are coupled to light sources 34a through respective interconnects 36a and 36a′. Further, interconnects 35b and 35b′ are coupled to light sources 34b through respective interconnects 36b and 36b′. This is better shown in FIG. 7 which is a simplified bottom view of canopy 30. In FIG. 7, interconnects 36a,36a′ and 36b,36b′, as well as lights 34a and 34b, are carried by respective panels 30a and 30b. Here, interconnects 36a,36a′ and 36b,36b′ are embedded in respective panels 30a and 30b. However, they can also be positioned on respective bottom surfaces 37a and 37b.

It should be noted that interconnects 25a,25a′ and 25b,25b′ are positioned in respective tongues 23a and 23b and interconnects 35a,35a′ and 35b,35b′ are positioned in respective grooves 33a and 33b in this example for illustrated purposes only. In other examples, interconnects 25a,25a′ and 25b,25b′ and interconnects 35a,35a′ and 35b,35b′ can be otherwise positioned so that they are electrically coupled together when canopy 30 engages fixture 20. The interconnects are shown as extending between ends 52 and 53 for illustrative purposes only. In some embodiments, the interconnects can be segmented so that they can communicate more signals between fixture 20 and canopy 30. These signals can include control signals from control circuitry 57 communicated to light sensor 27a and/or 27b. The interconnects can include metal strips of materials well known to those skilled in the art, such as aluminum (Al) and copper (Cu).

A simplified circuit diagram of the electrical connections between power supply 26, control circuitry 57, light sources 34a and 34b, and light sensors 27a and 27b is shown in FIG. 9a. A simplified circuit diagram of the electrical connections between power supply 46, control circuitry 58, light sources 44a and 44b, and light sensors 47 is shown in FIG. 9b. Light sources 34a and 34b are coupled to power supply 26 through light sensors 27a and 27b, respectively, to turn them on or off in response to the amount of ambient light received by them. If sign 15 includes phosphorescent material, then control circuitry 57 can be coupled to power supply 26 to turn lights 34a,34b on for a desired amount of time to make the phosphorescent material phosphoresce. Control circuitry 57 can then turn lights 34a,34b off and the steps can be repeated. Control circuitry 57 can be configured to turn lights off 34a,34b gradually, in which when turned off lights 34a,34b will dim gradually over a predetermined period of time, such as 2-5 seconds, until they are completely turned off.

Similarly, light sensor 47 is coupled to light sources 44a and 44b to turn them on or off in response to the amount of light received by it. Hence, light sensors 27a, 27b, and 47 can operate to turn on their corresponding light sources when it is too dark to see signs 15 and 42 easily. Conversely, light sensors 27a, 27b, and 47 can operate to turn off their corresponding light sources when it is bright enough to clearly see signs 15 and 42. Control circuitry 58 can operate in a manner similar to circuitry 57. It should be noted that manual switches or timers can be used instead of light sensors 27a, 27b, and 47 in some embodiments.

Fixture 20 can be configured in many different ways. Another example is shown in FIG. 3 which is a perspective view of a fixture 19. In this embodiment, fixture 19 includes walls 20a and 20b coupled to wall 20c so that they are parallel to each other and perpendicular to wall 20c. An intermediate wall 20d is positioned parallel to and spaced apart from wall 20c. Wall 20d is coupled between walls 20a and 20b so that a storage housing 25 is formed. Walls 20a-20d extend between ends 52 and 53. Housing 25 is used for holding items, such as business cards with contact information or fliers with more information about the property advertised by display apparatus 10. However, housing 25 can be used to hold other items.

The present invention is described above with reference to preferred embodiments. However, those skilled in the art will recognize that changes and modifications may be made in the described embodiments without departing from the nature and scope of the present invention. Various further changes and modifications will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A sign assembly comprising:
a fixture capable of being attached to a sign support structure; and
a canopy which engages the fixture to provide cover for the sign support structure.

2. The assembly of claim 1 wherein the canopy is foldable.

3. The assembly of claim 1 further including at least one first light source positioned on the canopy to illuminate at least a portion of a first sign held by the sign support structure.

4. The assembly of claim 3 further including electrical contacts which are frictionally engaged when the canopy engages the fixture.

5. The assembly of claim 4 further including a power supply which provides power to the first light source(s) through the electrical contacts.

6. The assembly of claim 1 wherein the canopy is capable of slideably engaging the fixture.

7. The assembly of claim 1 further including a sign holding fixture coupled to the canopy, the sign holding fixture including a slot for receiving a second sign.

8. The assembly of claim 7 wherein the sign holding fixture further includes at least one second light source positioned to illuminate at least a portion of the second sign.

9. A sign assembly comprising:
a fixture capable of being attached to a sign support structure; and
a foldable canopy capable of being attached to the fixture.

10. The assembly of claim 9 further including at least one light source attached to the foldable canopy to illuminate a sign held by the sign support structure.

11. The assembly of claim 10 further including light sensitive circuitry which operates the light source(s) in response to the amount of light received by the circuitry.

12. The assembly of claim 10 further including electrical contacts positioned on the fixture and foldable canopy, the electrical contacts being electrically engaged when the canopy is attached to the fixture.

13. The assembly of claim 12 further including a power supply positioned proximate to the fixture, the power supply providing power to the light sources(s) through the electrical contacts.

14. The assembly of claim 9 further including first and second electrical contacts positioned on the fixture and foldable canopy, respectively, the first and second electrical contacts being frictionally engaged when the fixture is attached to the foldable canopy.

15. The assembly of claim 14 further including a power supply which provides a power signal to the first and second electrical contacts.

16. The assembly of claim 9 wherein the canopy includes first and second panels hinged together so that the angle between the first and second panels is adjustable.

17. The assembly of claim 9 wherein the fixture and foldable canopy are slideably engaged with at least one tongue and groove structure.

18. A sign assembly comprising:
a fixture configured to be coupled to a sign support structure, the fixture including a first electrical contact; and
a canopy coupled to the fixture, the canopy including a second electrical contact which electrically engages the first electrical contact when the canopy is coupled to the fixture.

19. The assembly of claim 18 wherein the canopy includes first and second panels coupled together with a living hinge.

20. The assembly of claim 18 wherein the canopy is frictionally engaged to the fixture.

21. The assembly of claim 20 further including a power source carried by the fixture and coupled to the first electrical contact.

22. The assembly of claim 21 further including a first lighting system coupled to the second electrical contact.

23. The assembly of claim 18 further including a sign holding fixture coupled to the canopy, the sign holding fixture including a slot for receiving a second sign.

24. The assembly of claim 23 wherein the sign holding fixture includes a second lighting system for providing light to the second sign.

25. The assembly of claim 24 further including a second power supply which provides power to the second lighting system.

26. The assembly of claim 18 wherein the fixture includes a storage housing for holding items.

27. A sign assembly comprising:
a fixture removably attached to a post, the fixture including a first electrical contact;
a foldable canopy which slideably engages the fixture, the foldable canopy including a second electrical contact which engages the first electrical contact when the foldable canopy and fixture are engaged; and
a lighting system carried by the foldable canopy, the lighting system being electrically coupled to the second electrical contact.

28. The assembly of claim 27 wherein the fixture and canopy are frictionally coupled together with at least one tongue and groove structure so that they can be separated.

29. The assembly of claim 27 wherein the foldable canopy includes first and second panels hinged together.

30. The assembly of claim 27 wherein the first lighting system is positioned on the canopy to provide light in a first desired direction.

31. The assembly of claim 27 further including a sign holding fixture coupled to the foldable canopy, the sign holding fixture including a slot for holding a first sign.

32. The assembly of claim 31 wherein the sign holding fixture further includes a second lighting system positioned to provide light in a second desired direction.

33. The assembly of claim 32 further including separate power supplies which provide power to respective first and second lighting systems.

34. The assembly of claim 32 further including a light sensor which turns on or off at least one of the first and second lighting systems in response to the amount of light received by the light sensor.

35. The assembly of claim 27 further including a sign holding fixture coupled to the foldable canopy, the sign holding fixture providing mechanical support to the foldable canopy.

36. A display apparatus comprising:
a fixture removably attached to a post, the fixture including a first electrical contact; and
a foldable canopy coupled to the sign support structure, the foldable canopy including a second electrical contact coupled to at least one light source positioned to illuminate a first sign held by the post, the first and second electrical contacts being engaged when the foldable canopy is coupled to the fixture.

37. The apparatus of claim 36 further including a sign holding fixture coupled to the foldable canopy, the sign holding fixture including a slot for receiving a second sign.

38. The apparatus of claim 37 wherein the sign holding fixture includes at least one second light source positioned to illuminate the second sign.

39. The apparatus of claim 36 wherein the fixture and the foldable canopy are slideably engaged together so that they can be easily engaged and disengaged.

40. The assembly of claim 36 wherein the foldable canopy includes panels hinged together so that the angle between them is adjustable.

41. The assembly of claim 37 wherein at least one of the first and second signs includes a phosphorescent material.

42. The assembly of claim 36 further including a mechanical assembly coupled to the foldable canopy, the mechanical assembly providing mechanical support to the foldable canopy.
